(19) United States
(12) Patent Application Publication
(10) Pub. No.: US 2010/0085961 A1
(43) Pub. Date: Apr. 8, 2010

(54) METHOD, DEVICE, AND SYSTEM FOR SYNCHRONIZING TERMINAL STATE IN GENERIC ACCESS NETWORK

(75) Inventors: Yang Zhao, Shenzhen (CN); Wulin Weng, Shenzhen (CN)

Correspondence Address: Huawei Technologies Co., Ltd.;c/o Darby & Darby P.C., P.O. Box 770, Church Street Station, New York, NY, 10008-0770, US

(73) Assignee: HUAWEI TECHNOLOGIES CO., LTD., Shenzhen (CN)

(21) Appl. No.: 12/634,374

(22) Filed: Dec. 9, 2009

Related U.S. Application Data
(63) Continuation of application No. PCT/CN2008/071477, filed on Jun. 27, 2008.

(30) Foreign Application Priority Data
Jun. 29, 2007 (CN) 200710126793.1

(51) Int. Cl. H04L 12/66; H04J 3/06

(52) U.S. Cl. 370/352; 370/503

(57) ABSTRACT

The present invention relates to wireless communication, and discloses a method, a device, and a system for synchronizing a terminal state in a GAN to ensure that the GAN can know the relevant state context information of the terminal correctly. In the present invention, a network device of the GAN receives CS domain and/or PS domain state information reported by a terminal; and the network device processes the terminal registration information according to the received CS domain and/or PS domain state information. After the connection is reestablished between the terminal and the GAN, the terminal reports the CS domain and/or PS domain state information in the GAN mode to the GANC. The terminal may report the CS domain and/or PS domain state information in the GERAN/UTRAN mode to the GANC in the registration process. The terminal may also initiate a registration update process after the CS domain and/or PS domain state in the GERAN/UTRAN mode changes.

### CROSS-REFERENCE TO RELATED APPLICATIONS

This application is a continuation of International Application No. PCT/CN2008/071477, filed on Jun. 27, 2008, which claims priority to Chinese Patent Application No. 200710126793.1, filed on Jun. 29, 2007, both of which are hereby incorporated by reference in their entireties.

### FIELD OF THE INVENTION

The present invention relates to wireless communication, and in particular, to a method, a device, and a system for synchronizing a terminal state in a Generic Access Network (GAN).

### BACKGROUND

In order to ensure a GAN to handle one of Circuit-Switched (CS) domain service and Packet-Switched (PS) domain service or both domains services, a terminal needs to synchronize its state in the GAN mode and one of the Global System for Mobile communications, GSM, Enhanced Data rates for GSM Evolution, EDGE Radio Access Network (GERAN) mode and Universal Terrestrial Radio Access Network (UTRAN) mode to the GAN network. On the one hand, the terminal needs to report its state in one of the GERAN mode and UTRAN mode to the GAN when performing registration towards the GAN; on the other hand, the terminal also needs to synchronize its state in the GAN mode to the GAN network if the connection between the terminal and a Generic Access Network Controller (GANC) is abnormal when the terminal works in the one of the GAN mode, GERAN mode and UTRAN mode.

The terminal may report its state in the GERAN/UTRAN mode to the GANC in the registration procedure, including the following steps.

Step 1: The terminal sends a registration request to the specified GANC. The registration request includes the state information of the terminal in the GERAN/UTRAN. The structure of the state information is shown in FIG. 2. A GRS information element (IE) indicates the state of the terminal in the GERAN/UTRAN, namely, Global System for Mobile communications, GSM Radio Resource/UTRAN Radio Resource Control state (GSM RR/UTRAN RRC state), to ensure that the GANC knows the working status of the terminal in the current GERAN/UTRAN correctly. All possible values of the GRS IE are shown in FIG. 3.

Step 2: After receiving the registration request, the GANC judges whether to accept the registration, and sends a response to the terminal. The response may be the registration acceptance, registration rejection, or redirection to another GANC.

Step 3: The terminal operations according to the response from the GANC.

The procedure of synchronizing the terminal state in the GAN mode to the GANC is as follows.

After the terminal sets up a lower-layer connection (such as TCP connection) with the GANC, the terminal sets up a signaling connection and a data transmission channel to transmit user data. In this way, the terminal is able to handle one of the PS domain service and the CS domain service separately or simultaneously. When the terminal works in one of the GAN mode, the GERAN mode and the UTRAN mode, once the TCP connection between the terminal and the GANC is abnormal, the terminal attempts to reestablish a TCP connection with the GANC. After the TCP connection is reestablished, the terminal sends synchronization information to the GANC. The synchronization information carries Generic Access-Resource Control/Generic Access-Circuit Switched Resources (GA-RC/GA-CSR) state information of the terminal, as shown in FIG. 4. A URS IE indicates the state of the terminal in the GA-RC/GA-CSR. After receiving the synchronization information, the GANC judges whether to set up, hold or terminate the CS domain service according to the terminal state carried in the synchronization information. All possible values of the URS IE are shown in FIG. 5.

However, in the process of implementing the present invention, the inventor discovers that the values of the GRS IE shown in FIG. 3 cover only the state of the terminal in the CS domain, and do not cover the state of the terminal in the PS domain (namely, General Packet Radio Service (GPRS)). Therefore, when the terminal reports the state through a registration procedure, the GANC is unable to know the working status of the terminal in the GPRS.

Likewise, when the terminal synchronizes the state information in the GAN mode to the GAN network, the terminal reports only the GA-RC/GA-CSR state, and does not report the PS domain state in the GAN. Therefore, the GANC is unable to judge whether it is necessary to set up, hold or terminate the PS domain service. For example, when the terminal is in one of the GA-CSR dedicated state and GA-PSR active state, a process of redirecting the mobile terminal to another GANC should not be initiated. In this case, if the GANC does not know the PS domain state correctly, the GANC may initiate a redirection procedure, which leads to interruption of the PS domain service.

Additionally, in the process of implementing the present invention, the inventor discovers that: When the terminal initiates a registration update process to the GANC after completion of the GAN registration, if the terminal is in the GERAN/UTRAN mode, the terminal does not report the state information in the GERAN/UTRAN mode (including at least one of the CS domain and PS domain). Consequently, the GANC is unable to know the at least one of CS domain and PS domain state information of the terminal in the GERAN/UTRAN mode.

Moreover, if the working state of the terminal in the GERAN/UTRAN mode changes, the terminal is unable to notify the GANC to update the state information in time.

### SUMMARY

The embodiments of the present invention provide a method, a device, and a system for synchronizing terminal state in a GAN to ensure that the GAN can know the relevant state context information of the terminal correctly.

A method for synchronizing terminal state in a GAN provided in an embodiment of the present invention includes:
receiving, by a network device of the GAN, at least one of CS domain and PS domain state information reported by a terminal; and
processing, by the network device, the terminal according to the at least one of the received CS domain and PS domain state information.

A GAN network device provided in another embodiment of the present invention includes:
a receiving unit, configured to receive at least one of CS domain and PS domain state information from a terminal; and
a processing unit, configured to process the terminal according to the at least one of the CS domain and PS domain state information received by the receiving unit.

A terminal device provided in another embodiment of the present invention includes:
a reporting unit, configured to report at least one of CS domain and PS domain state information to a GAN network device.

A system for synchronizing a terminal state is provided in another embodiment of the present invention. The system includes the network device and the terminal device described above.

Compared with the conventional art, the embodiments of the present invention bring the following benefits.

The terminal reports the at least one of the CS domain and PS domain state information to the GAN network device, and the network device processes the terminal according to the at least one of the received CS domain and PS domain state information. The GAN can receive the at least one of the CS domain and PS domain state information of the terminal in time, thus ensuring the GAN to know the integrality of the state context information of the terminal and handle the at least one of the CS domain and PS domain services of the terminal correctly.

### BRIEF DESCRIPTION OF THE DRAWINGS

FIG. 1 is a simplified schematic diagram illustrating six states related to the GAN mode in the conventional art;

FIG. 2 is a simplified schematic diagram illustrating a structure of state information in GERAN/UTRAN-mode reported by the terminal in the conventional art;

FIG. 3 is a simplified schematic diagram illustrating values of a GRS IE in the conventional art;

FIG. 4 is a simplified schematic diagram illustrating a structure of GAN mode state information in GAN mode reported by the terminal in the conventional art;

FIG. 5 is a simplified schematic diagram illustrating values of a URS IE in the conventional art;

FIG. 6 is a simplified schematic diagram illustrating a method for synchronizing a terminal state in a GAN in a first embodiment of the present invention;

FIG. 7 is a simplified schematic diagram illustrating a structure of state information in GERAN/UTRAN-mode reported by the terminal in the first embodiment of the present invention;

FIG. 8 is a simplified schematic diagram illustrating values of a GRS IE in the first embodiment of the present invention;

FIG. 9 is a simplified schematic diagram illustrating a method for synchronizing a terminal state in a GAN in a second embodiment of the present invention;

FIG. 10 is a simplified schematic diagram illustrating a method for synchronizing a terminal state in a GAN in a third embodiment of the present invention;

FIG. 11 is a simplified schematic diagram illustrating a method for synchronizing a terminal state in a GAN in a fourth embodiment of the present invention;

FIG. 12 is a simplified schematic diagram illustrating a structure of GAN mode state information in GAN mode reported by the terminal in the fourth embodiment of the present invention;

FIG. 13 is a simplified schematic diagram illustrating values of a URS IE in the fourth embodiment of the present invention; and

FIG. 14 is a simplified schematic diagram illustrating a structure of GAN network device and a terminal device in a fifth and sixth embodiments of the present invention.

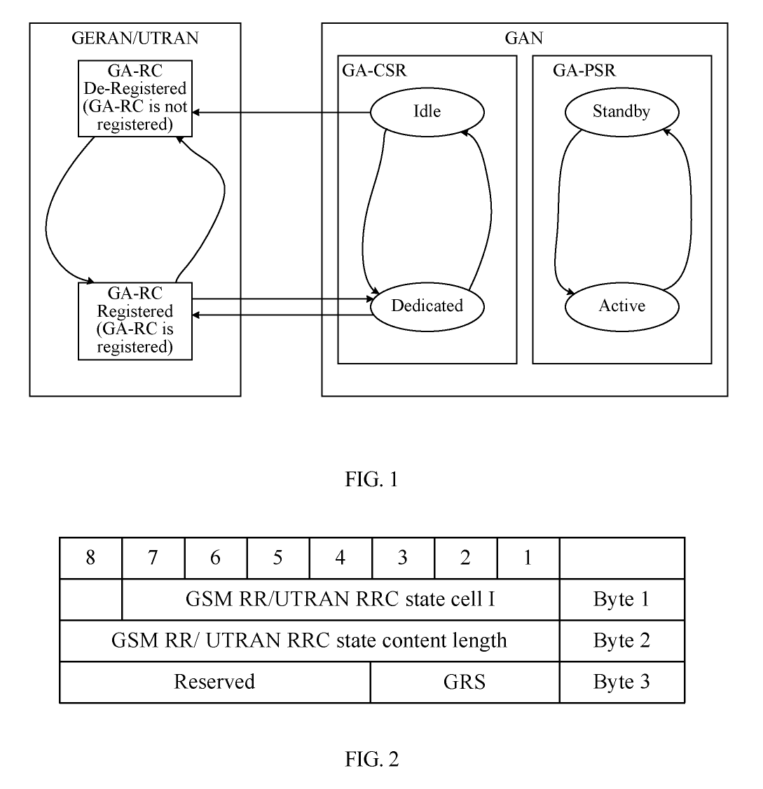

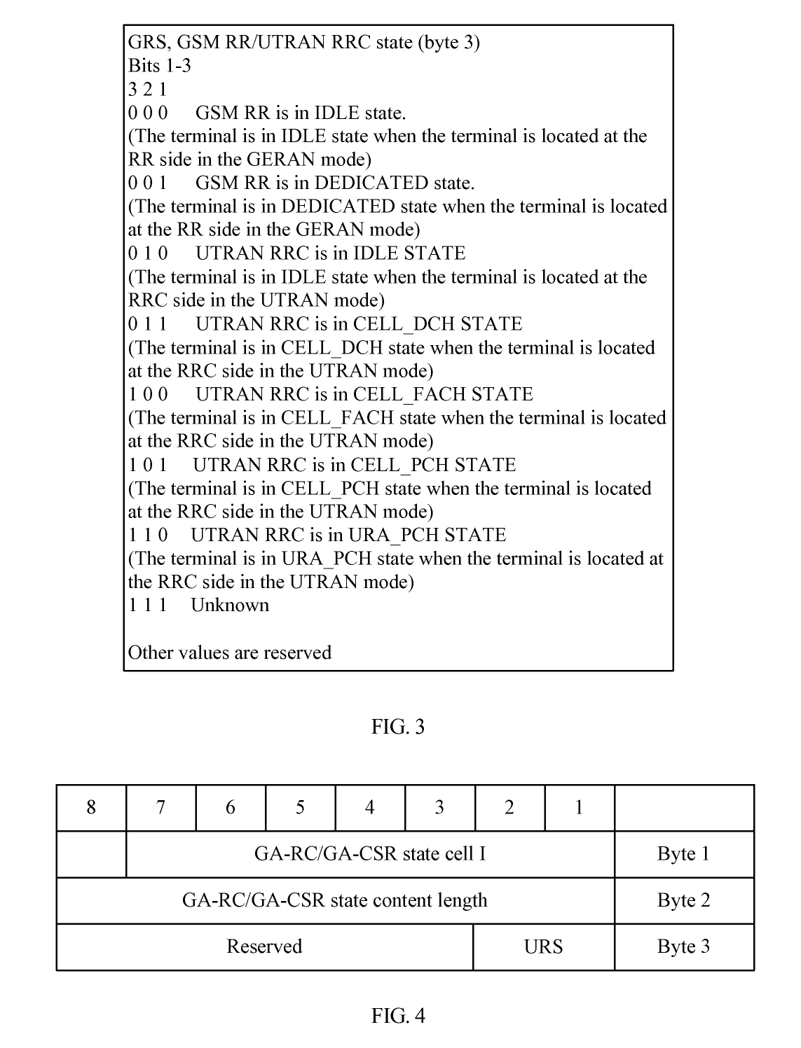

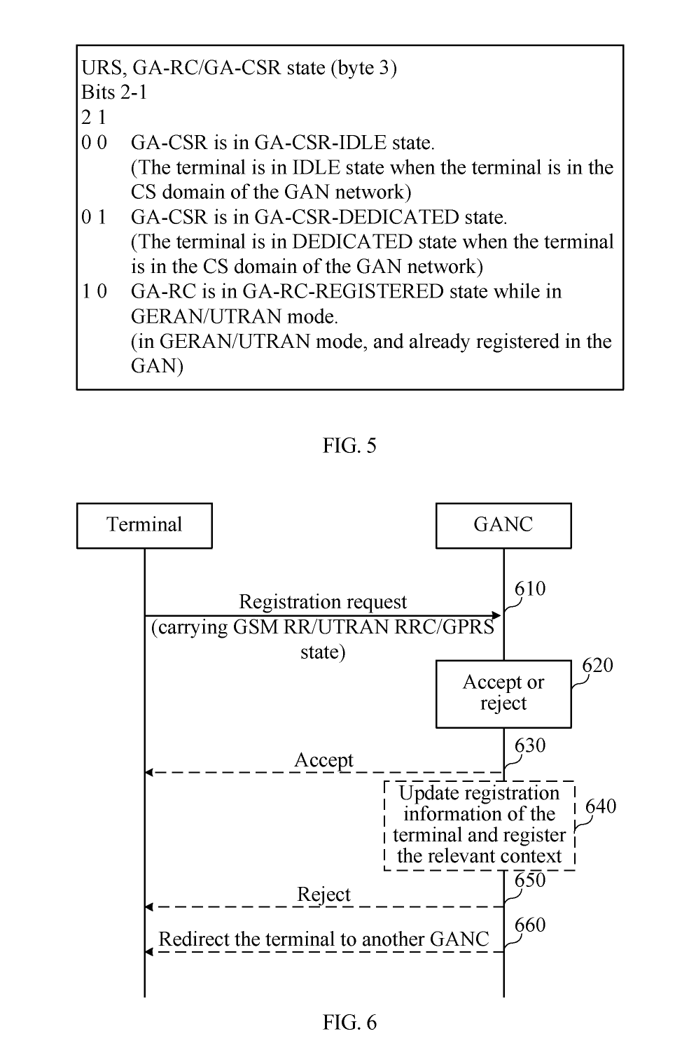

### DETAILED DESCRIPTION

In order to make the technical solution, objectives and merits of the present invention clearer, the following describes the embodiments of the present invention in more detail with reference to accompanying drawings.

A method for synchronizing terminal state in a GAN is provided in a first embodiment of the present invention. In this embodiment, when a terminal initiates a registration to the GAN, the terminal reports at least one of the CS domain state information and PS domain state information in a GERAN/UTRAN mode. If the network device accepts the registration of the terminal, the network device updates the registration information of the terminal and registration relevant context according to the at least one of the received CS domain state information and PS domain state information in the GERAN/UTRAN mode.

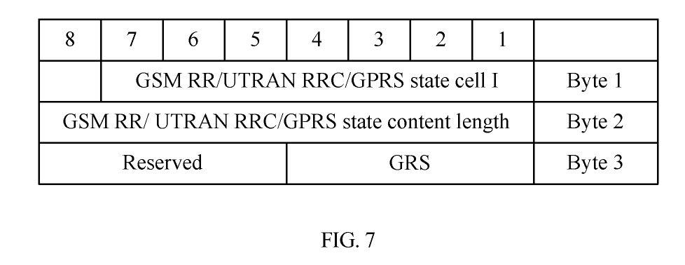

FIG. 6 is a simplified schematic diagram illustrating the detailed process. In step 610, the terminal sends a registration request to the GANC. The registration request carries the at least one of the CS domain state information and PS domain state information of the terminal in the GERAN mode and UTRAN mode. As shown in FIG. 7, the state information includes at least one of GSM Radio Resource (RR) state information, UTRAN Radio Resource Control (RRC) state information, and GPRS state information of the terminal. The state information is included in the GRS IE. The GRS IE includes four bits. It is understandable that the layout of the four bits occupied by the GRS IE is not necessarily the layout shown in FIG. 7, and the layout is appropriate if the bits are not occupied by other IEs. For example, the GRS IE may occupy any four bits in byte 3. Besides, the GRS IE does not necessarily occupy only four bits, but may occupy more, e.g. five or six bits.

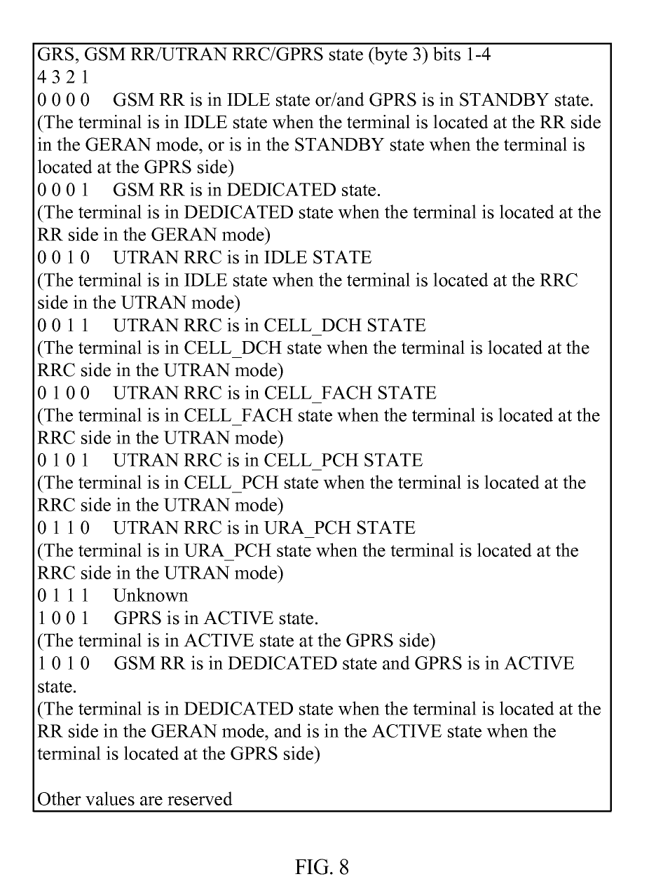

FIG. 8 is a simplified schematic diagram illustrating all possible values of the GRS IE and the meanings of the values.

“0000” indicates that the terminal, in the GERAN mode, is in at least one of the idle state when the terminal is located at the RR layer and the standby state when the terminal is located at the GPRS layer.

“0001” indicates that the terminal, in the GERAN mode, is in the dedicated state when the terminal is located at the RR layer.

“0010” indicates that the terminal is in the idle state when the terminal is located at the RRC layer in the UTRAN mode.

“0011” indicates that the terminal is in the cell dedicated channel (CELL_DCH) state when the terminal is located at the UTRAN RRC layer in the UTRAN mode.

“0100” indicates that the terminal is in the cell forward channel (CELL_FACH) state when the terminal is located at the RRC layer in the UTRAN mode.

“0101” indicates that the terminal is in the cell paging channel (CELL_PCH) state when the terminal is located at the RRC layer in the UTRAN mode.

“0110” indicates that the terminal is in the routing area paging channel (URA_PCH) state when the terminal is located at the RRC layer in the UTRAN mode.

“0111” indicates that the terminal state is unknown.

“1001” indicates that the terminal is in the active state at the GPRS layer.

“1010” indicates that the terminal is in the dedicated state when the terminal is located at the RR layer and in the active state when the terminal is located at GPRS layer in the GERAN mode.

It is understandable that the values of the GRS IE and their meanings are not limited to the examples given in FIG. 8. For example, other values of the GRS IE may include the following content.

“0010” means that the terminal is in at least one of the idle state when the terminal is located at the RR layer in the GERAN mode, and the standby state when the terminal is located at the GPRS layer;

“0011” means that the terminal is in the dedicated state when the terminal is located at the RR layer in the GERAN mode;

“0110” means that the terminal is in the idle state when the terminal is located at the RRC layer in the UTRAN mode;

“0001” means that the terminal is in the cell dedicated channel (CELL_DCH) state when the terminal is located at the RRC layer in the UTRAN mode;

“0111” means that the terminal is in the cell forward channel (CELL_FACH) state when the terminal is located at the RRC layer in the UTRAN mode;

“1101” means that the terminal is in the cell paging channel (CELL_PCH) state when the terminal is located at the RRC layer in the UTRAN mode;

“1110” means that the terminal is in the routing area paging channel (URA_PCH) state when the terminal is located at the RRC layer in the UTRAN mode;

“0000” means that the terminal state is unknown;

“1001” means that the terminal is in the active state at the GPRS layer; and

“1111” means that the terminal is in the dedicated state when the terminal is located at the RR layer in the GERAN mode, and is in the active state at the GPRS layer, and so on.

In step 620, after receiving the registration request, the GANC judges whether to accept the registration. If accepting the registration, step 630 is performed, i.e. the GANC returns a response indicative of acceptance to the terminal; if rejecting the registration, step 650 is performed, i.e. the GANC returns a response indicative of rejection to the terminal, or step 660 is performed, i.e. the GANC returns a response indicative of redirecting the terminal to another GANC.

Step 640 occurs after step 630. In step 640, after accepting the registration request from the terminal, the GANC updates the registration information of the terminal and the registration relevant context according to the state information in the GERAN/UTRAN-mode in the registration request. The state information in one of the GERAN mode and UTRAN mode received by the GANC includes one of the GSM RR state information, the UTRAN RRC state information and the GPRS state information, namely, includes at least one of the CS domain state information and PS domain state information in the UTRAN/GERAN mode. The state information is complete, and therefore, the GANC may handle at least one of the CS domain services and the PS domain services of the terminal correctly.

The operations performed after the terminal receives the response from the GANC are the same as those in the conventional art, and are not repeated here any further.

A method for synchronizing a terminal state in a GAN is provided in a second embodiment of the present invention. In this embodiment, when the terminal requests a registration update request procedure to the GAN, the terminal reports at least one of the CS domain state information and PS domain state information in the GERAN/UTRAN mode. If the network device accepts the registration update request of the terminal, the network device initiates the registration information of the terminal and the registration relevant context according to the received state information in the GERAN/UTRAN mode.

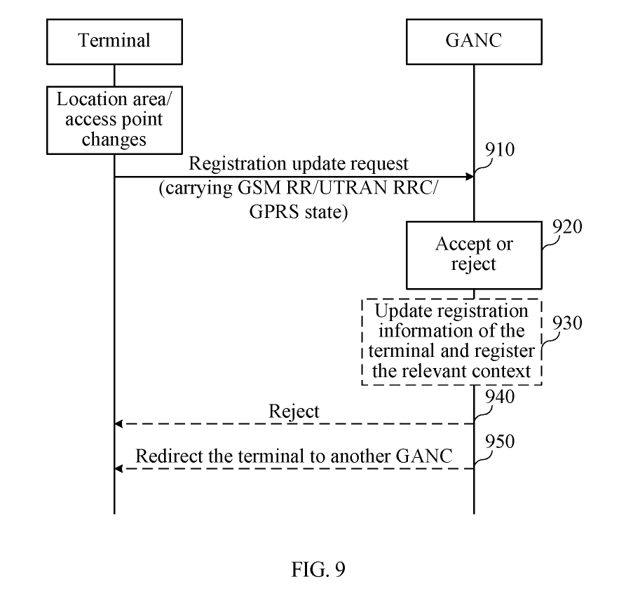

FIG. 9 is a simplified schematic diagram illustrating the detailed process. In step 910, when one of position area and access point of the terminal in the GERAN/UTRAN changes, the terminal initiates a registration update process, i.e. the terminal sends a registration update request to a network device, for example, the GANC. The registration update request carries the state information of the terminal in the GERAN/UTRAN mode. As shown in FIG. 7, the state information includes at least one of the GSM RR state information, UTRAN RRC state information, and GPRS state information of the terminal. The state information is set in the GRS IE. The GRS IE includes four bits. It is understandable that the layout of the four bits occupied by the GRS IE is not necessarily the layout shown in FIG. 7, and the layout is appropriate if the bits are not occupied by other cells. For example, the GRS IE may occupy any four bits in byte 3. Besides, the GRS IE does not necessarily occupy only four bits, but may occupy five or six bits.

FIG. 8 is a simplified schematic diagram illustrating all possible values of the GRS IE and the meanings of the values.

“0000” means that the terminal is in at least one of idle state when the terminal is located at the RR layer in the GERAN mode, and standby state when the terminal is located at the GPRS layer.

“0001” means that the terminal is in the dedicated state when the terminal is located at the RR layer in the GERAN mode.

“0010” means that the terminal is in the idle state when the terminal is located at the RRC layer in the UTRAN mode.

“0011” means that the terminal is in the cell dedicated channel (CELL_DCH) state when the terminal is located at the RRC layer in the UTRAN mode.

“0100” means that the terminal is in the cell forward channel (CELL_FACH) state when the terminal is located at the RRC layer in the UTRAN mode.

“0101” means that the terminal is in the cell paging channel (CELL_PCH) state when the terminal is located at the RRC layer in the UTRAN mode.

“0110” means that the terminal is in the routing area paging channel (URA_PCH) state when the terminal is located at the RRC layer in the UTRAN mode.

“0111” means that the terminal state is unknown; “1001” means that the terminal is in the active state at the GPRS layer.

“1010” means that the terminal is in the dedicated state when the terminal is located at the RR layer in the GERAN mode, and is in the active state at the GPRS layer.

It is understandable that the values of the GRS IE and their meanings are not limited to the examples given in FIG. 8. For example, other values of the GRS IE may be:

“0010” means that the terminal is in the at least one of the idle state when the terminal is located at the RR layer in the GERAN mode, and the standby state when the terminal is located at the GPRS layer;

“0011” means that the terminal is in the dedicated state when the terminal is located at the RR layer in the GERAN mode;

“0110” means that the terminal is in the idle state when the terminal is located at the RRC layer in the UTRAN mode;

“0001” means that the terminal is in the cell dedicated channel (CELL_DCH) state when the terminal is located at the RRC layer in the UTRAN mode;

“0111” means that the terminal is in the cell forward channel (CELL_FACH) state when the terminal is located at the RRC layer in the UTRAN mode;

“1101” means that the terminal is in the cell paging channel (CELL_PCH) state when the terminal is located at the RRC layer in the UTRAN mode;

“1110” means that the terminal is in the routing area paging channel (URA_PCH) state when the terminal is located at the RRC layer in the UTRAN mode;

“0000” means that the terminal state is unknown;

“1001” means that the terminal is in the active state at the GPRS layer; and

“1111” means that the terminal is in the dedicated state when the terminal is located at the RR layer in the GERAN mode, and is in the active state at the GPRS layer, and so on.

In step 920, after receiving the registration update request, the GANC judges whether to accept the registration update or not. If accepting the registration update, the step 930 is performed; if rejecting the registration update request, the step 940 is performed, i.e. the GANC returns a response indicative of rejection to the terminal, or the step 950 is performed, i.e. the GANC a response indicative of redirecting the terminal to another GANC.

In step 930, after accepting the registration update request of the terminal, the GANC updates the registration information of the terminal and the registration relevant context according to at least one of the CS domain state information and PS domain state information in the GERAN/UTRAN-mode in the registration update request. The terminal state in the UTRAN/GERAN mode may be changed due to the changing of one of the location area and access point of the terminal in the GERAN/UTRAN. Through the state information reported in the registration update process, the GANC knows the latest state information of the terminal. The state information in one of the GERAN mode and UTRAN-mode received by the GANC includes at least one of the GSM RR state information, UTRAN RRC state information and GPRS state information, namely, includes at least one of the CS domain state information and PS domain state information in the UTRAN/GERAN mode. The state information is complete, and therefore, the GANC may handle at least one of the CS domain and PS domain services of the terminal correctly.

Afterward, the operations performed between the terminal and the GANC are the same as those in the conventional art, and are not repeated here any further.

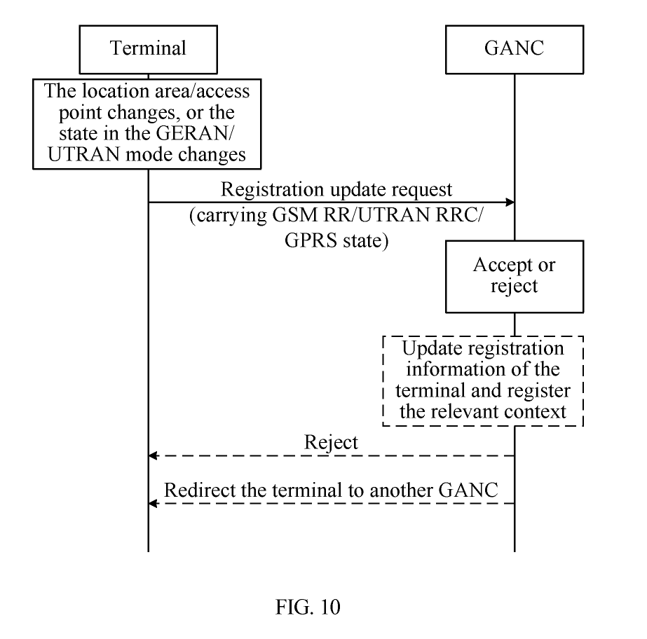

A method for synchronizing a terminal state in a GAN is provided in a third embodiment of the present invention. The solution of the third embodiment is almost the same as that of the second embodiment except that: In the second embodiment, when the location area or access point of the terminal in the GERAN/UTRAN changes, the terminal initiates the registration update process, and reports at least one of the CS domain state information and PS domain state information of the terminal in the GERAN/UTRAN mode to the GAN network device; but in the third embodiment, the terminal initiates a registration update process not only when the location area or access point of the terminal in the GERAN/UTRAN changes, but also when at least one of the CS domain state and PS domain state of the terminal in the GERAN/UTRAN mode changes, and the terminal reports the current state information of the terminal in the GERAN/UTRAN mode to the GAN network device, as shown in FIG. 10. Therefore, when the terminal state changes, the GAN is notified to update the state information in time; and the GAN updates the registration information of the terminal and the registration relevant context, and the GAN may handle at least one of the CS domain service and PS domain service of the terminal correctly.

A method for synchronizing a terminal state in a GAN is provided in a fourth embodiment of the present invention. In this embodiment, after a connection is reestablished between the terminal and the GAN, the terminal reports at least one of the CS domain state information and PS domain state information in the GAN mode to the GAN network device. According to the received state information in the GAN mode, the network device updates the registration information of the terminal and the registration relevant context.

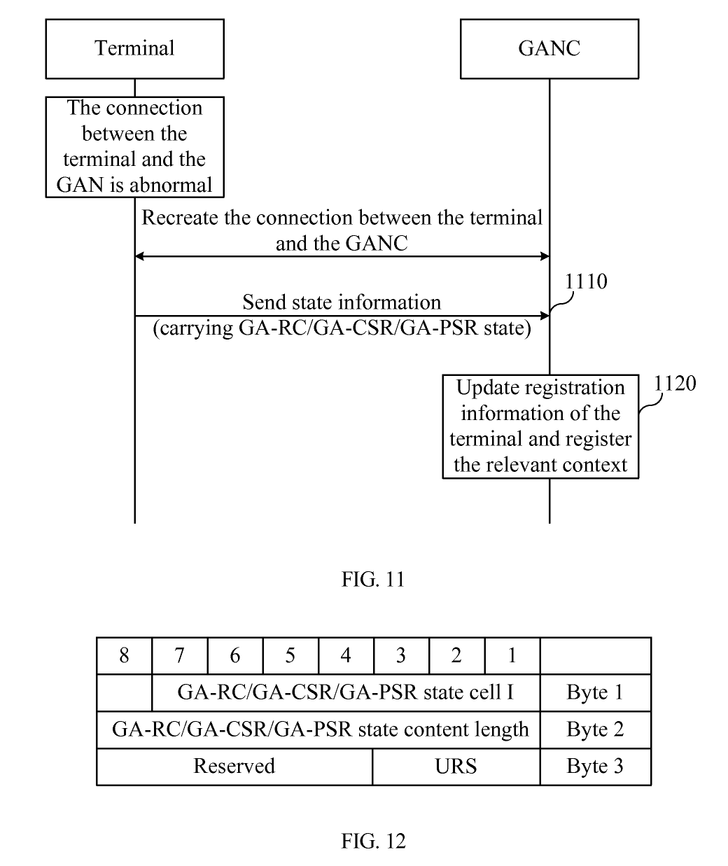

FIG. 11 is a simplified schematic diagram illustrating the detailed process. In this embodiment, after a connection is set up between the terminal and the GANC, if the terminal works in one of the GAN mode, the GERAN mode and the UTRAN mode, and the connection between the terminal and the GANC is abnormal, for example, discontinuous, the terminal attempts to reestablish a connection with the GANC.

After the connection is reestablished, step 1110 is performed, i.e. the terminal reports at least one of the CS domain state information and PS domain state information in the GAN mode to the GANC. As shown in FIG. 12, the reported state information includes at least one of the GA-RC state information, GA-CSR state information, and GA-PSR state information of the terminal, and the state information is set in a URS IE. The URS IE includes three bits. It is understandable that the layout of the three bits occupied by the URS IE is not necessarily the layout shown in FIG. 12, and the layout is appropriate only if the bits are not occupied by other cells. For example, the URS IE may occupy any three bits in byte 3. Besides, the URS IE does not necessarily occupy only three bits, but may occupy four or five bits.

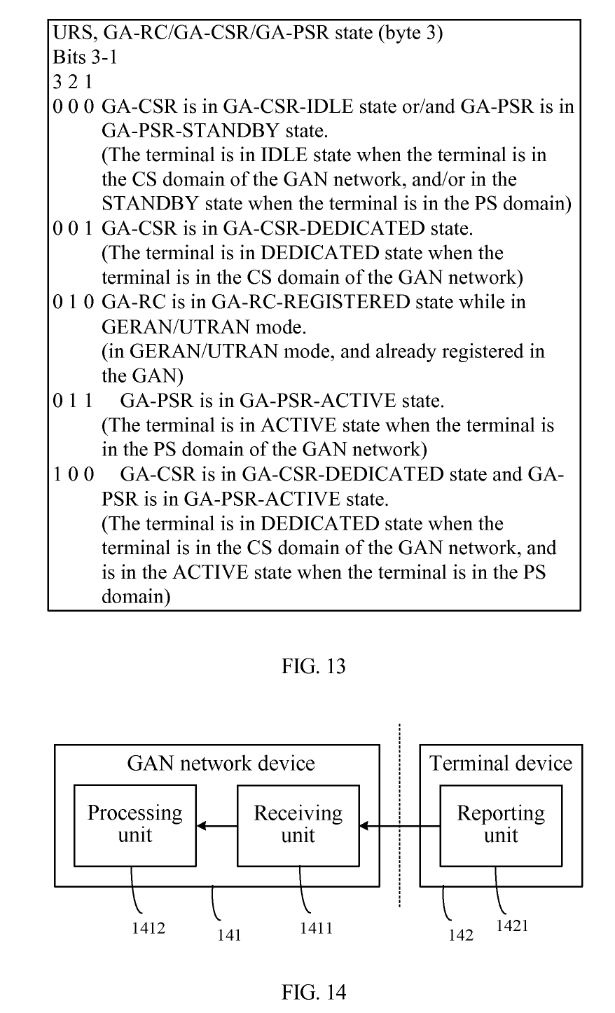

All possible values of the URS IE and their meanings are shown in FIG. 13.

“000” indicates that the terminal is in at least one of the idle state in the CS domain of the GAN, and the standby state in the PS domain of the GAN.

“001” means that the terminal is in the dedicated state in the CS domain of the GAN.

“010” means that the terminal is in the GERAN/UTRAN mode and is registered in the GAN.

“011” means that the terminal is in the active state in the PS domain of the GAN.

“100” means that the terminal is in the dedicated state in the CS domain of the GAN, and is in the active state in the PS domain.

It is understandable that the values of the URS IE and their meanings are not limited to those shown in FIG. 13. For example, it is possible that:

“001” means that the terminal is in at least one of the idle state in the CS domain of the GAN, and the standby state in the PS domain of the GAN;

“010” means that the terminal is in the dedicated state in the CS domain of the GAN;

“000” means that the terminal is in the GERAN/UTRAN mode and is registered in the GAN;

“100” means that the terminal is in the active state in the PS domain of the GAN; and

“111” means that the terminal is in the dedicated state in the CS domain of the GAN, and is in the active state in the PS domain, and so on.

In step 1120, the GANC updates the registration information of the terminal according to the at least one of the received CS domain state information and PS domain state information and the registration relevant context. The GAN mode state information in the GAN mode received by the GANC includes one of the GA-RC state information, GA-CSR state information, and GA-PSR state information, namely, includes the at least one of the CS domain state information and PS domain state information in the GAN mode. The state information is complete, and therefore, the GANC may handle at least one of the CS domain service and PS domain service of the terminal correctly.

A GAN network device is provided in a fifth embodiment of the present invention. The network device may be a GANC. As shown in FIG. 14, the network device 141 includes: a receiving unit 1411, configured to receive at least one of CS domain state information and PS domain state information from a terminal 142; and a processing unit 1412, configured to process the terminal 142 according to the at least one of the CS domain state information and PS domain state information received by the receiving unit 1411. The GAN may receive the at least one of the CS domain state information and PS domain state information of the terminal 142 simultaneously, thus ensuring the GAN to know the complete state context information of the terminal 142 and handle the at least one of the CS domain state information and PS domain services of the terminal 142 correctly.

The state information received by this receiving unit 1411 may be at least one of the CS domain state information and PS domain state information in the GAN mode. After a connection is reestablished between the terminal and the GAN, the terminal 142 reports the state information to the GAN network device 141. The processing unit 1412 may include a first updating subunit, which is configured to update registration information of the terminal 142 and the registration relevant context according to the at least one of the GAN mode CS domain state information and PS domain state information in the GAN mode received by the receiving unit 1411.

Alternatively, the receiving unit 1411 may receive the state information in one of the registration process and the registration update process of the terminal 142. In this case, the state information received by the receiving unit 1411 is at least one of the CS domain state information and PS domain state information in one of the GERAN mode and UTRAN mode. The processing unit 1412 may include a second updating subunit, which is configured to update the registration information of the terminal and the registration relevant context according to the at least one of the CS domain state information and PS domain state information in the one of the GERAN mode and UTRAN-mode received by the receiving unit 1411. The network device 141 may further include a judging unit, which is configured to judge whether to accept one of the registration and the registration update of the terminal 142, and instruct the second updating subunit to update the registration information and the registration relevant context if accepting the one of the registration and the registration update.

A terminal device is provided in the sixth embodiment of the present invention. As shown in FIG. 14, the terminal device 142 includes a reporting unit 1421, which is configured to report at least one of CS domain state information and PS domain state information to the GAN network device 141. The network device may be a GANC.

The reporting unit 1421 may include: a GAN reporting subunit, configured to report the at least one of the CS domain state information and PS domain state information in the GAN mode to a network device 141. The terminal device 142 may further include a reestablishing unit, which is configured to initiate a process of reestablishing a connection between the terminal 142 and the GAN, and notify the GAN reporting subunit to report the state information after reestablishing the connection. Therefore, when the terminal 142 is in one of the GAN mode, the GERAN mode and the UTRAN mode, after the connection between the terminal 142 and the GANC is abnormal, the terminal 142 may notify the correct state information of the terminal to the network device 141 in time upon completion of reestablishing the connection, and the GAN may update the registration information of the terminal 142 correctly and the registration relevant context.

Alternatively, the terminal 142 may further include: at least one of a registering unit and a registration updating unit. The registering unit is configured to initiate a registration process to the GAN network device 141. The registration updating unit is configured to initiate a registration update process to the GAN network device 141. The reporting unit 1421 may include: a traditional network reporting subunit, configured to report at least one of the CS domain state information and PS domain state information in one of the GERAN and UTRAN mode to the network device 141 in one of the registration process initiated by the registering unit and in the registration update process initiated by the registration updating unit. Therefore, after completion one of registering the terminal 142 and updating the registration, the GAN network may obtain the correct state information of the terminal 142 in time, and handle the at least one of the CS domain service and PS domain service of the terminal 142 correctly.

The registration updating unit initiates a registration update process if one of the following conditions is fulfilled: The location area of the terminal 142 in one of the GERAN and UTRAN changes, the access point of the terminal 142 in one of the GERAN and UTRAN changes, the CS domain state of the terminal 142 in one of the GERAN mode and UTRAN mode changes, and the PS domain state of the terminal 142 in one of the GERAN mode and UTRAN mode changes. If one of the location area and access point of the terminal 142 in one of the GERAN and UTRAN changes, the terminal 142 state in one of the UTRAN mode and GERAN mode may change. Through reporting the state information in the registration update process, the GANC knows the latest state information of the terminal 142.

A system for synchronizing a terminal state is provided in a seventh embodiment of the present invention. The system includes the network device 141 provided in the fifth embodiment and the terminal device 142 provided in the sixth embodiment. The details of the system are not repeated here any further.

In conclusion, in the embodiments of the present invention, the terminal reports at least one of the CS domain state information and PS domain state information to the GAN network device, and the network device processes the terminal according to the at least one of the received CS domain state information and PS domain state information. The GAN may receive at least one of the CS domain state information and PS domain state information of the terminal simultaneously, thus ensuring the GAN to know the complete state context information of the terminal and handle at least one of the CS domain service and PS domain service of the terminal correctly.

After a connection is reestablished between the terminal and the GAN, the terminal reports the at least one of the CS domain state information and PS domain state information in the GAN mode to the GANC. Therefore, when the terminal is in one of the GAN mode, the GERAN mode and the UTRAN mode, after the connection between the terminal and the GANC is abnormal, the GAN network may obtain the correct state information of the terminal in time upon completion of reestablishing the connection, and update the registration information of the terminal correctly and the registration relevant context.

In the registration process, the terminal reports the at least one of the CS domain state information and PS domain state information in one of the GERAN mode and UTRAN mode to the GANC. Therefore, after completion of registering the terminal, the GAN network may obtain the correct state information of the terminal in time, and handle at least one of the CS domain service and PS domain service of the terminal correctly.

In the registration update process, the terminal reports the at least one of the CS domain state information and PS domain state information in one of the GERAN mode and UTRAN mode to the GANC. Therefore, after the location area or access point of the terminal in one of the GERAN and UTRAN changes, the GAN network may obtain the correct state information of the terminal in time, and handle at least one of the CS domain service and PS domain services of the terminal correctly.

The terminal may also initiate a registration update process after at least one of the CS domain state and PS domain state in one of the GERAN mode and UTRAN mode changes. Therefore, the GAN network may obtain the correct state information of the terminal in time, and handle at least one of the CS domain state and PS domain service of the terminal correctly.

According to the foregoing embodiments, those skilled persons in the art are clearly aware that the embodiments of the present invention may be implemented through hardware, or through software in addition to a necessary universal hardware platform, but the latter is preferred in most circumstances. Therefore, the technical solution under the present invention or the contributions to the conventional art may be fully or partially embodied as a software product. The software product may be stored in a computer-readable storage medium (for example, one of ROM/RAM, magnetic disk, and CD) and may incorporate several instructions for instructing a computer device (for example, one of personal computer, server, and network device) to execute the method specified in all or part of the embodiments of the present invention.

Although the invention has been described through several preferred embodiments, the invention is not limited to such embodiments. It is apparent that those skilled in the art can make modifications and variations to the invention without departing from the spirit and scope of the invention. The invention is intended to cover the modifications and variations provided that they fall in the scope of protection defined by the following claims or their equivalents.

What claims is claimed:

1. A method for synchronizing terminal state in a Generic Access Network, GAN, comprising:
receiving, by a network device of the GAN, Circuit-Switched, CS, domain state information and Packet-Switched, PS, domain state information reported by a terminal; and
updating, by the network device, state information of the terminal according to the received CS domain state information and PS domain state information.

2. The method of claim 1, wherein the network device is a Generic Access Network Controller, GANC.

3. The method of claim 1, further comprising:
receiving, after a connection is reestablished between the terminal and the GAN, the CS domain state information and PS domain state information in a GAN mode reported by the terminal; and
updating, by the network device, registration information of the terminal and registration relevant context according to the received CS domain state information and PS domain state information.

4. The method of claim 3, wherein the CS domain state information and PS domain state information in the GAN mode comprises one of:
information indicating that the terminal is in at least one of idle state of the CS domain in the GAN, and standby state in the PS domain of the GAN;
information indicating that the terminal is in a dedicated state of the CS domain in the GAN;
information indicating that the terminal is in an active state of the PS domain in the GAN;
information indicating that the terminal is in a dedicated state of the CS domain in the GAN and is in an active state of the PS domain in the GAN; and
information indicating that the terminal is in one of a Global System for Mobile communications, GSM, Enhanced Data rates for GSM Evolution, EDGE, Radio Access Network, GERAN, mode and a Universal Terrestrial Radio Access Network, UTRAN, mode and the terminal is registered in the GAN.

5. The method of claim 1, further comprising:
receiving the CS domain state information and PS domain state information in one of a GERAN mode and a UTRAN mode reported by the terminal in a registration process; and
updating, by the network device, registration information of the terminal and registration relevant context, according to the received CS domain state information and PS domain state information, if the network device accepts the registration of the terminal.

6. The method of claim 5, wherein the CS domain state information and PS domain state information in one of the GERAN mode and UTRAN mode comprise one of:
information indicating that the terminal is in at least one of idle state when the terminal is located at of the GSM RR Radio Resource Control, RRC, layer in the GERAN mode and standby state when the terminal is located at General Packet Radio Service, GPRS, side in the GERAN mode;
information indicating that the terminal is in a dedicated state when the terminal is located at the GSM RRC layer in the GERAN mode;
information indicating that the terminal is in an idle state when the terminal is located at the RRC layer in the UTRAN mode;
information indicating that the terminal is in a cell dedicated channel, CELL_DCH, state of the RRC layer when the terminal is located at the RRC side in the UTRAN mode;
information indicating that the terminal is in a cell forward channel, CELL_FACH, state of the RRC layer when the terminal is located at the RRC layer in the UTRAN mode;
information indicating that the terminal is in a cell paging channel, CELL_PCH, state of the RRC layer when the terminal is located at the RRC layer in the UTRAN mode;
information indicating that the terminal is in a routing area paging channel, URA_PCH, state of the RRC layer when the terminal is located at the RRC layer in the UTRAN mode;
information indicating that the terminal is in an active state of the GPRS layer;
information indicating that the terminal is in a dedicated state when the terminal is located at the RRC layer in the GERAN mode and is in an active state at the GPRS RR layer; and
information indicating that the terminal state is unknown.

7. The method of claim 1, further comprising:
receiving the CS domain state information and PS domain state information in one of a GERAN mode and a UTRAN mode reported by the terminal in a registration update process; and
updating, by the network device, registration information of the terminal and registration relevant context, according to the received CS domain state information and PS domain state information, if the network device accepts the registration update of the terminal.

8. The method of claim 7, further comprising:
initiating, by the terminal, the registration update process if one of the following conditions is fulfilled:
location area of the terminal in one of the GERAN and UTRAN changes;
access point of the terminal in one of the GERAN and UTRAN changes;
the CS domain state of the terminal in one of the GERAN mode and UTRAN mode changes; and
the PS domain state of the terminal in one of the GERAN mode and UTRAN mode changes.

9. The method of claim 1, further comprising:
receiving, by the network device, a registration request carrying the CS domain state information and PS domain state information of the terminal in one of GERAN mode and UTRAN mode sent from the terminal.

10. The method of claim 1, wherein the CS domain state information and PS domain state information of the terminal comprise GSM Radio Resource, RR, state information, UTRAN Radio Resource Control, RRC, state information, and GPRS state information of the terminal.

11. The method of claim 1, wherein the CS domain state information and PS domain state information of the terminal are contained in a GRS information element, IE.

12. A Generic Access Network, GAN, network device, comprising:
a receiving unit, configured to receive Circuit-Switched, CS, domain state information and Packet-Switched, PS, domain state information from a terminal; and
a processing unit, configured to process the terminal according to the CS domain state information and PS domain state information received by the receiving unit; wherein the processing unit comprises a first updating subunit, configured to update registration information of the terminal and registration relevant context according to the CS domain state information and PS domain state information in a GAN mode received by the receiving unit.

13. The GAN network device of claim 12, wherein the receiving unit is further configured to receive state information in one of registration procedure and registration update procedure of the terminal, and the state information received by the receiving unit comprises CS domain state information and PS domain state information in one of Global System for Mobile communications, GSM, Enhanced Data rates for GSM Evolution, EDGE, Radio Access Network, GERAN, mode and Universal Terrestrial Radio Access Network, UTRAN, mode; and
the processing unit further comprises a second updating subunit, configured to update registration information of the terminal and register relevant context according to the CS domain state information and PS domain state information in the one of the GERAN mode and UTRAN-mode received by the receiving unit; and
the network device further comprises a judging unit, configured to judge whether to accept one of the registration and the registration update of the terminal, and instruct the second updating subunit to update the registration information and registration relevant context if accepting the one of the registration and the registration update request.

14. The GAN network device of claim 12, wherein the CS domain state information and PS domain state information of the terminal comprise GSM Radio Resource, RR, state information, UTRAN Radio Resource Control, RRC, state information, and GPRS state information of the terminal.

15. The GAN network device of claim 12, wherein the CS domain state information and PS domain state information of the terminal are contained in a GRS information element, IE.

16. A terminal device, comprising:
a reporting unit, configured to report Circuit-Switched, CS, domain state information and Packet-Switched, PS, domain state information to a Generic Access Network, GAN, network device.

17. The terminal device of claim 16, wherein the reporting unit further comprises:
a GAN reporting subunit, configured to report CS domain state information and PS domain state information in GAN mode to a network device; and
the terminal device further comprises:
a reestablishing unit, configured to initiate a process of reestablishing a connection between the terminal and the GAN, and notify the GAN reporting subunit to report the CS domain state information and PS domain state information in the GAN mode after the connection is reestablished.

18. The terminal device of claim 16, wherein the terminal device further comprises: at least one of a registering unit and a registration updating unit, and
the registering unit is configured to initiate a registration process to the GAN network device;
the registration updating unit is configured to initiate a registration update process to the GAN network device; and
the reporting unit further comprises:
a traditional network reporting subunit, configured to report CS domain state information and PS domain state information in one of Global System for Mobile communications, GSM, Enhanced Data rates for GSM Evolution, EDGE, Radio Access Network, GERAN, mode and Universal Terrestrial Radio Access Network, UTRAN, mode to the network device in one of the registration procedure initiated by the registering unit and in the registration update procedure initiated by the registration updating unit.

19. The terminal device of claim 18, wherein the registration updating unit is configured to initiate the registration update process if one of the following conditions is fulfilled:
a location area of the terminal in one of the GERAN and UTRAN changes;
an access point of the terminal in one of the GERAN and UTRAN changes;
the CS domain state of the terminal in one of the GERAN mode and UTRAN mode changes, and
the PS domain state of the terminal in one of the GERAN mode and UTRAN mode changes.
